(19) United States
(12) Patent Application Publication
(10) Pub. No.: US 2008/0072078 A1
(43) Pub. Date: Mar. 20, 2008

(54) INFORMATION PROCESSOR AND INFORMATION PROCESSING METHOD

(75) Inventor: Takafumi ITO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/834,201

(22) Filed: Aug. 6, 2007

(30) Foreign Application Priority Data
Sep. 19, 2006 (JP) 2006-253480

(51) Int. Cl. G06F 12/14; G06F 1/32; G06F 12/16; G06F 9/30

(52) U.S. Cl. 713/194; 712/225; 713/323; 712/E09.016

(57) ABSTRACT

An information processor includes a first storage device mounted in a main body of the information processor, a storage device attaching section to/from which a second storage device can be attached/detached, a network interface device, an instruction device configured to give a store instruction to store information, and a division processing unit configured to divide predetermined information to which the store instruction is applied so as to generate first divided information and second divided information. In addition, the information processor includes a controller configured to perform control to store the first divided information and the second divided information in the first storage device and the second storage device respectively, and control to store the second divided information in a third storage device connected to a network.

### CROSS REFERENCE TO RELATED APPLICATION

This application is based upon and claims the benefit of priority from the prior Japanese Patent Application No. 2006-253480 filed on Sep. 19, 2006; the entire contents of which are incorporated herein by reference.

### BACKGROUND OF THE INVENTION

1. Field of the Invention

The present invention relates to an information processor and information processing method which are suitable for maintaining security of information and the like.

2. Description of the Related Art

In recent years, there has been a problem that confidential information such as personal information is leaked due to the loss or theft of an information processor such as a personal computer (hereinafter abbreviated as PC).

While means configured to encrypt information when the information is stored on a hard disk (hereinafter abbreviated as HDD) in a PC is generally employed for protection of information, it is not impossible that encryption is broken by analysis of the encryption or detection of a password for decryption, and therefore further effective information protection means is desired.

As means or method for solving this problem, when information is stored as one file, the information is divided into two or more pieces of information, and the information is distributed between and stored in an HDD in a PC and a flash memory device (such as an SD™ card or a USB memory) that is removable from the PC.

Then, the flash memory device is kept in a different location from the PC so that the complete information cannot be restored even if information stored in one side is decrypted (see http://www.iodata.jp/prod/storage/option/2005/e-walv3p/index.htm).

The means or method described in this document is effective as measures against information leakage, but has disadvantages as follows:

(a) A flash memory device is often a removable storage device and has a small size, and thus is relatively likely to be lost or damaged. Therefore, if the device is lost or damaged, restoring of the information is difficult even for a user as an original owner of the information.

(b) In a case where a flash memory device such as an SD™ card that is attached to a PC by inserting the device in a slot is used as a storage means for storing one of the divided information, there is a possibility that a user of the PC finishes the use of the PC when the SD™ card or the like still has been attached into the slot so that the SD™ card remains attached after the use of the PC.

In this case, the function to protect the information that is stored and divided for maintaining security is reduced because the SD™ card remains attached to the PC. Additionally, when the PC is a notebook PC, the PC may be carried with the card attached thereto. In this case, the effect to maintain security of the information is also reduced because the flash memory device remains attached to the PC when the PC has been lost.

Although the means or method according to the above document is effective as the measure against information leakage as described above, such means or method can be further improved in consideration of usage patterns by users.

Specifically, such means or method should be improved in a way that original user can easily restore information, a flash memory device is separated from a PC when a user stops the use of the PC so that a condition in which security is maintained can be easily set, and so on.

In addition, in Japanese Patent Laid-Open No. 8-44597, a method is disclosed for storing large volume information such as dictionary information into multiple storage media whose capacity is larger than that of one storage medium.

In the method of this patent application, information is divided to be stored into multiple storage media, wherein some information from information stored in one of storage media is stored into a space area of another storage medium redundantly. By this method, operations for exchanging storage media are reduced.

The method according to the above patent application does not address information leakage. Therefore, the method does not solve either of the above disadvantages (a) and (b).

### SUMMARY OF THE INVENTION

An information processor according to one embodiment of the present invention includes:

a first storage device configured to be able to store information, the first storage device being mounted in a main body of the information processor;

a storage device attaching section to/from which a second storage device configured to be able to store information can be attached/detached, the storage device attaching section being provided in the main body of the information processor;

a network interface device configured to connect with a network, the network interface device being provided in the main body of the information processor;

an instruction device configured to give a store instruction to store information;

a division processing unit configured to divide predetermined information to which the store instruction is applied so as to generate first divided information and second divided information; and

a controller configured to perform control to store the first divided information and the second divided information in the first storage device and the second storage device respectively, and control to store the second divided information to be stored in the second storage device into a third storage device connected to the network through the network interface device.

An information processor according to one embodiment of the present invention includes:

a first storage device in which a first divided information that is divided from predetermined information is stored, the first storage device being mounted in a main body of the information processor;

a storage device attaching section to/from which a removable second storage device can be attached/detached, the storage device attaching section being provided in the main body of the information processor, the removable second storage device storing second divided information which is other divided information than the first divided information divided from the predetermined information; and

a controller configured to, when an instruction to make a transition to a low power consumption mode including at least one of shutdown, standby, and pause processing is given in a condition where the second storage device has been attached to the storage attaching section, perform control or alert for inhibiting the transition.

An information processing method according to one embodiment of the present invention includes:

dividing predetermined information into first divided information and second divided information in response to a store instruction with respect to the predetermined information; and

storing the first divided information in a first storage device mounted in a main body of an information processor configured to perform information processing, and storing the second divided information in a second storage device removably attached to the main body of the information processor as well as in a third storage device on a network through a network interface provided in the main body of the information processor.

### BRIEF DESCRIPTION OF THE DRAWINGS

FIG. 1 is a block diagram which shows a schematic configuration of a PC as an information processor according to one embodiment of the present invention;

FIG. 2 is a flowchart which shows details of a process for storing a confidential file;

FIG. 3 is a flowchart which shows details of a process for reading out a confidential file;

FIG. 4 is a flowchart which shows details of a process in a case where connection of a network or attachment of an SD™ card is detected; and

FIG. 5 is a flowchart which shows details of a process in a case where an instruction to make a transition to shutdown, standby, or hibernation is detected.

### DETAILED DESCRIPTION OF THE PREFERRED EMBODIMENTS

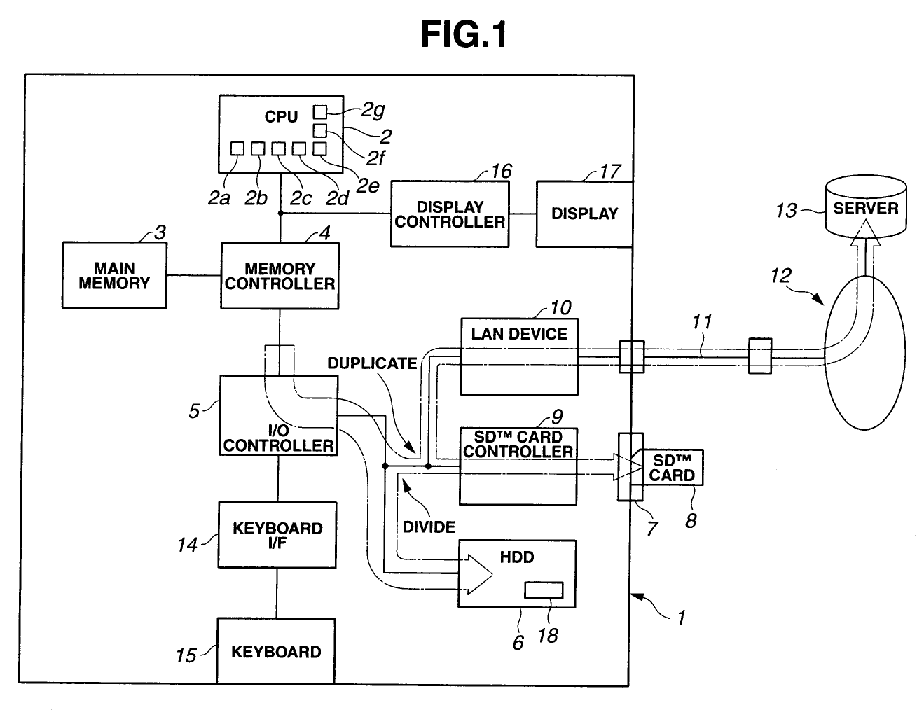

FIG. 1 shows a schematic configuration of a personal computer (hereinafter abbreviated as PC) 1 as an information processor according to one embodiment of the present invention.

PC 1 has a CPU 2 which performs control of components of the PC 1 and data processing. The CPU 2 controls a memory controller 4 which controls a main memory 3, and also controls an input/output controller (abbreviated as I/O controller) 5.

The I/O controller 5 is connected to, for example, a hard disk (abbreviated as HDD) 6 as a first storage device provided inside the PC 1, an SD™ card controller 9 which controls an SD™ card 8 as a second storage device which can be attached to and detached from an SD™ card slot 7 provided through a housing of PC 1, that is, removable from the PC 1, and a LAN device 10.

The LAN device 10 is connected to, for example, a LAN network 12 through a LAN cable 11 removably connected to a connecting section of the LAN device 10.

Thus, the PC 1 is connected to the network 12 through, for example, the LAN device 10 as a network interface means, and thereby the PC 1 can be connected to a server 13 as a third storage device provided on the network 12.

In addition, a keyboard 15 is connected to the CPU 2 through a keyboard interface 14 connected to the I/O controller 5, and a user can control operation of the CPU 2 by inputting an instruction to store information or data through the keyboard 15. In other words, the keyboard 15 makes up a store instruction means configured to give an instruction to store a confidential file or the like including information which a user wants to keep secret. Additionally, the user can also give an instruction to reproduce a stored confidential file from the keyboard 15.

In addition, the PC 1 is provided with a display 17 as a display means through a display controller 16 controlled by the CPU 2. The display 17 is used for visually providing a message or alert to a user as described later.

Although, as the PC 1 whose schematic configuration shown in FIG. 1, a notebook computer is assumed in which the CPU 2, the HDD 6, the keyboard 15, the display 17, etc. are integrated in the main body of the PC, the PC 1 may also be applied to a case of a desktop computer in which the CPU 2 and the HDD 6 are mounted in the main body of the PC, and separate keyboard 15 and display 17 are removably connected to the main body of the PC respectively.

In the HDD 6, a program data 18 as an application software which operates on a basic software executed by the CPU 2 is stored.

The program data 18 is loaded from the HDD 6 by the CPU 2 after the PC 1 is powered on and the CPU 2 is started by the basic software.

When predetermined data (also referred to just as data), that is, confidential information whose security should be maintained and which is created, edited, etc. by a user is stored as a confidential file in the storage device by the CPU 2 according to a program of the program data 18, the CPU 2 performs processing for encrypting the data and dividing the encrypted data on a per bit basis, for example, into two pieces of data.

In other words, the CPU 2 has an encryption function 2a configured to encrypt data and a divide function 2b configured to divide the data according to the program.

In addition, when two pieces of data divided as described above are stored, the CPU 2 performs control operation to store one and the other of the two pieces of data in the HDD 6 mounted in PC 1 and the SD™ card 8 respectively. The SD™ card 8 is a small flash memory device that is nonvolatile, electrically rewritable, and removably connected to the PC 1. In other words, the CPU 2 has a division storage control function 2c configured to perform control to divide and store data.

In addition, the CPU 2 performs control operation to store the other data stored in the SD™ card 8 also into the server 13 on the network 12. In other words, the CPU 2 has a backup storage control function configured to back up data stored in the SD™ card 8, or a duplication function 2d configured to duplicate data.

In FIG. 1, division by the above described divide function 2b and duplication by the duplication function 2d in a case of storage as a confidential file are illustrated schematically by bold arrows drawn with chain double-dashed lines.

In addition, when an instruction to make a transition to the low power consumption mode such as a shutdown of the PC 1 is given by an instruction through the keyboard 15 or the like from a user, the CPU 2 that performs control operation according to the program determines whether or not the SD™ card 8 has been attached to PC 1. When the SD™ card 8 has been attached, the CPU 2 also performs control operation to provide an alert by displaying a message or the like to prompt removal of the SD™ card 8 from the PC 1 or to inhibit the transition to the low power consumption mode by rejecting the transition instruction or the like.

In other words, the CPU 2 has an alert/inhibition function 2e with respect to the instruction to make a transition to the low power consumption mode with the SD™ card attached.

Further, when the PC 1 reads out a stored confidential file according to the above described program, the PC 1 according to the present embodiment also performs processing of a file combining function 2f configured to read out divided files A, B and combines the files into one file, a decryption function 2g configured to decrypt the encrypted combined file, and the like.

In the present embodiment, the CPU 2 serves both as processing function such as encryption and division, and control function to perform the control to store one divided data in the HDD 6 inside the PC 1 and the control to store the other divided data in the SD™ card 8 or the like removably attached to the PC 1. However, the present invention is not limited to the case where the CPU 2 serves both as the processing function such as division and the control function as described above. For example, such functions may be distributed between a plurality of CPUs or between a CPU and a DSP (Digital Signal Processor).

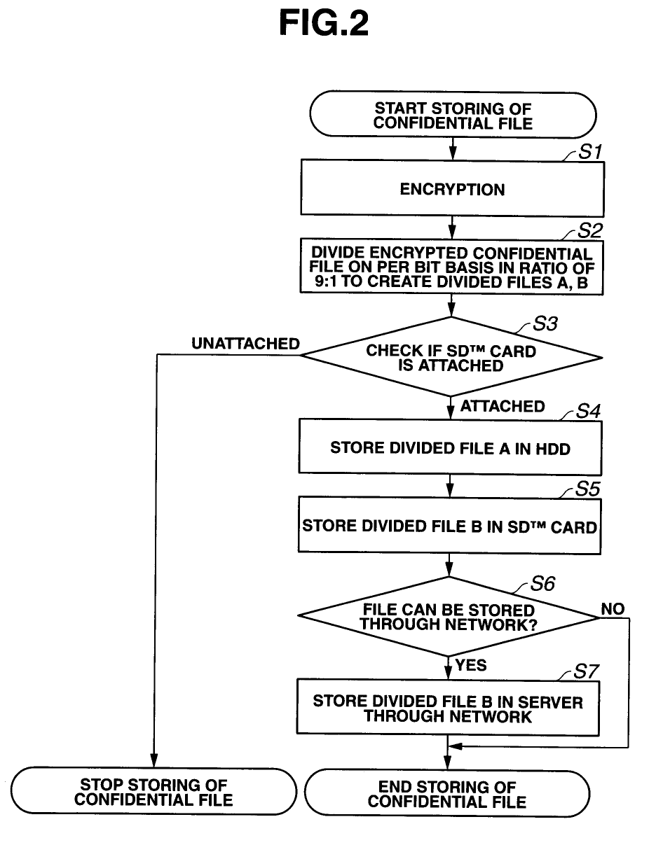

Operation of the PC 1 according to one embodiment having a configuration as described above will now be described. When a user powers on the PC 1 and passes an authentication process such as a password entry, the CPU 2 becomes operable on a basic software, and then loads the program data 18 so as to be able to perform various control operations illustrated in FIGS. 2 to 5.

The user creates confidential information whose security should be maintained by operation of the keyboard 15 or the like, and inputs a store instruction from the keyboard 15 or the like in order to store the confidential information as a confidential file.

Then, the CPU 2 performs a control process as shown in FIG. 2 to store the confidential file.

The CPU 2 expands a confidential file to be stored, for example, into the main memory 3 through the memory controller 4, and performs encryption processing on the file as shown in step S1. The confidential file to be stored is one which has been temporarily stored in, for example, the HDD 6. And, the confidential file which has been temporarily stored in the HDD 6 is erased after the process of FIG. 2 is normally completed.

In the next step S2, the CPU 2 divides the encrypted confidential file on a per bit basis in a ratio of 9:1 of data amount (information amount) to create a divided file A and a divided file B. Further, to the divided file A and the divided file B, additional information for identifying counterparts of the two divided files are added respectively.

In the next step S3, the CPU 2 checks whether the SD™ card 8 has been attached or not. Specifically, the CPU 2 checks whether or not the SD™ card 8 has been attached into the SD™ card slot 7.

When the CPU 2 determines that the SD™ card 8 has not been attached into the SD™ card slot 7, the CPU 2 stops storing of the confidential file.

Alternatively, when the SD™ card 8 has not been attached into the SD™ card slot 7, the CPU 2 may display a massage to prompt attachment of the SD™ card 8 on the display 17 before stopping storing of the confidential file, start time measurement for example, and return to step S3.

Then, the CPU 2 may stop storing of the confidential file when the SD™ card 8 is not attached even if a certain period of time has elapsed after starting time measurement.

On the other hand, when it is determined that the SD™ card 8 has been attached in step S3, the CPU 2 performs processing for storing the divided file A having a larger amount of data in the HDD 6 in step S4. In the next step S5, the CPU 2 performs processing for storing the divided file B having a smaller amount of data in the SD™ card 8.

In the next step S6, the CPU 2 determines whether or not the information can be stored through the network 12 via the LAN device 10 (or on the network 12) i.e., whether or not the information can be duplicated.

In this case, whether or not a user has an access right to a predetermined area of the server 13 in which the divided file B will be stored is checked (authenticated), and only a user who passes the check can access the predetermined area.

When it is determined that the information can be stored through the network 12, the CPU 2 stores the divided file B that is the same as stored in the SD™ card 8 into the predetermined area of the server 13 through the network 12 in step S7, and normally completes storing of the confidential file.

On the other hand, when it is determined that the information cannot be stored through the network in step S6, the CPU 2 completes storing of the confidential file without performing processing of step S7. In this case, the divided file B is stored only in the SD™ card 8.

By provision of the operation contents as shown in FIG. 2, a confidential file is encrypted before being stored, and further divided into two divided files A, B on a per bit basis.

Thereby, a confidential file is sufficiently prevented from leaking to anyone other than an original user unless both of the divided file A and the divided file B are available. Thus, the PC 1 can sufficiently ensure the security function with respect to information whose security should be maintained.

The SD™ card 8 is small and may be lost or damaged. If the SD™ card 8 is damaged or the like, it is difficult even for an original user who owns a confidential file to restore the confidential file. However, in the present embodiment, in an environment where the PC 1 has been connected to the network 12, a backup file of an information file to be stored in the SD™ card 8 is created on the server 13.

Therefore, if the SD™ card 8 is damaged or the like, the user can restore the confidential file using the backup file with security maintained. Thus, the present embodiment enhances user convenience.

In addition, the present embodiment enhances user convenience in consideration of various usage patterns of users by allowing a confidential file to be divided and stored also in an environment in which the PC 1 cannot connected to the server 13.

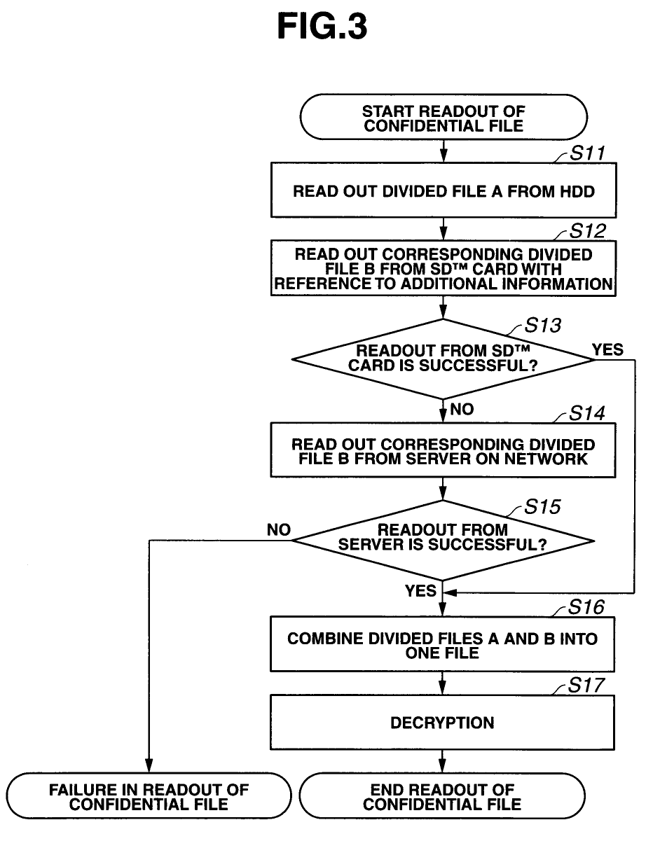

FIG. 3 shows an operation for reading out (reproducing) a divided and stored confidential file.

When an instruction to read out (reproduce) a confidential file is entered from the keyboard 15 by a user with respect to the divided file A stored in the HDD 6, the CPU 2 performs a process shown in FIG. 3 to reproduce the confidential file.

When the readout of the confidential file is started, the CPU 2 reads out the divided file A to which the read out instruction is applied from the HDD 6 in the first step S11.

Further, to the divided file A, there is added additional information such as a name of a divided file B for identifying the divided file B which is a counterpart of the divided file A.

Then, in the next step S12, the CPU 2 performs processing for reading out the divided file B corresponding the divided file A from the SD™ card 8 with reference to the additional information.

In the next step S13, the CPU 2 determines whether or not the divided file B corresponding to the divided file A has been successfully read out from the SD™ card 8.

When the readout is successful, the process proceeds to step S116, and, when the readout fails on the contrary, the process proceeds to step S14.

In the step S14, the CPU 2 performs processing for reading out the divided file B from the server 13 on the network 12.

In the next step S15, the CPU 2 determines whether or not the divided file B has been successfully read out from the server 13.

When the readout from the server 13 is not successful, the readout of the confidential file of FIG. 3 fails and the process is terminated.

On the other hand, when the readout from the server 13 is successful, the process proceeds to the next step S16, and the CPU 2 combines the divided file A and the divided file B into one file in the step S16. In other words, reverse processing of the division processing in step S2 of FIG. 2 is performed so that the divided files become the encrypted confidential file prior to being divided.

In the next step S17, the CPU 2 performs reverse processing of encryption in step S1 of FIG. 2, i.e., decryption to restore the confidential file prior to being stored, and completes the readout of the confidential file in FIG. 3. By the way, if it is selected that encryption is not performed in step S1, decryption processing of step S17 is not performed.

The PC 1 according to the present invention is provided with operation contents shown in FIG. 3 so that, even if the SD™ card 8 is damaged or lost, the PC 1 can restore a divided file B by reading out a same content as the divided file B that is stored in the SD™ card 8 through a network, thus enhancing user convenience.

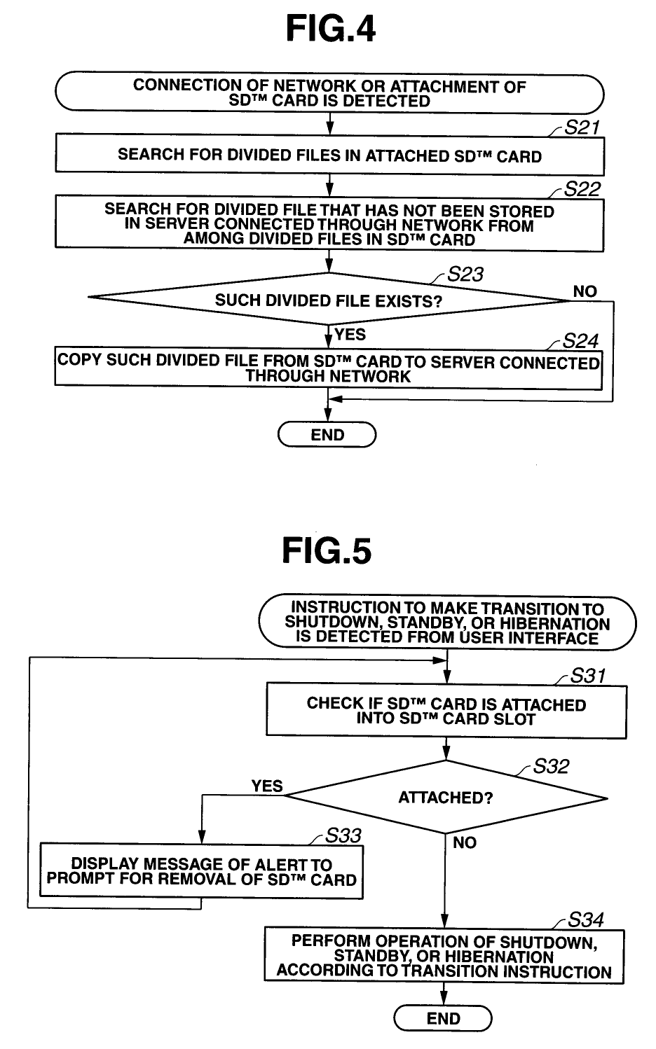

FIG. 4 shows operation contents about synchronization of divided files which are stored in the SD™ card 8 and the server 13 on the network 12.

When a confidential file is stored or a stored divided file is read out, the SD™ card 8 has been attached to the PC 1 as shown in FIG. 1 as a normal usage condition. In this case, it is desirable that the PC 1 has been connected to the network 12.

However, the PC 1 may be used by a user in a condition where only the SD™ card 8 has been connected to the PC 1 or the PC 1 has been connected to the network 12, that is, a condition where only one of them has been connected to the PC 1. Accordingly, there may be a case where a usage condition is changed during use or from a prior usage condition so that both of them are connected to the PC 1 due to connection of the network or attachment of the SD™ card 8.

The PC 1 according to the present embodiment has a function configured to synchronize divided files as confidential information stored in the server 13 and the SD™ card 8 when the PC 1 detects connection of the network or attachment of the SD™ card as shown in FIG. 4.

When connection of a network or attachment of an SD™ card is detected, the CPU 2 searches for a divided file in the attached SD™ card 8 in the first step S21.

In a case where a divided file B has been stored in the SD™ card 8 as a result of the process of FIG. 2, the CPU 2 searches for the divided file B. In a case where another divided file aside from the divided file B has been stored, the CPU 2 also searches for the another divided file.

In the next step S22, the CPU 2 searches for a divided file not stored in the network-connected server 13 from among divided files stored in the SD™ card 8.

In the next step S23, the CPU 2 determines the presence or absence of a divided file stored not in the server 13 but in the SD™ card 8. When the CPU 2 determines that there is no divided file stored not in the server 13 but in the SD™ card 8, the CPU 2 completes the process of FIG. 4.

For example, if there are divided files B, C in the SD™ card 8, the CPU 2 searches for divided files B, C stored in the server 13. When the divided files B, C have been stored also in the server 13, the CPU 2 completes the process of FIG. 4.

On the other hand, for example, when only the divided file B has been stored in the server 13, it is determined that there is the divided file C corresponding to the determination of step S23. In this case, the CPU 2 copies the divided file C from the SD™ card 8 to the network-connected server 13 in the next step S24. Then, the process of FIG. 4 is completed.

By provision of the operation contents of FIG. 4, in a case where, for storing a confidential file, the PC 1 stores a divided file in the SD™ card 8 when the PC 1 has not been connected to the network, the PC 1 can store the divided file also in the server 13.

That is to say, when the CPU 2 detects, for example, a network connection, the CPU 2 searches for divided files stored in the SD™ card 8, and automatically stores into the server 13 a divided file which has not been stored in the network-connected server 13 among the divided files found by the search. Therefore, when a user stores the divided file in the SD™ card 8 without connection to the network, the divided file stored in the SD™ card 8 is not backed up in the server 13 still without the connection to the network. However, when the network connection is detected, the CPU 2 automatically stores the divided file also in the server 13. Thereby, a function configured to restore a confidential file can be ensured and operations of the function can be automated so that user convenience can be enhanced.

In addition, the process of FIG. 4 is also performed when the SD™ card 8 is attached in a condition where the PC has been connected to the network.

When the PC 1 according to the present embodiment detects an instruction to make a transition to a low power consumption mode such as shutdown, standby, or hibernation (pause) from a user interface such as the keyboard 15, a power switch, or a menu, the PC 1 performs a process as shown in FIG. 5. The low power consumption mode as used herein refers to a mode in a low power consumption state transited from a power consumption in normal usage. The low power consumption state also includes a case where power is off, i.e., a power consumption is 0.

The hibernation is a function by which data of the main memory 3 just prior to the power-off of the PC 1 is stored in the HDD 6 before the PC 1 is powered off, and, next time the power is on, the data is expanded in the main memory 3 from the HDD so that the condition just prior to the power-off can be set in a short time. In the standby mode, the low power consumption state is achieved by setting the screen of the display 17 to be shut off, the HDD to be powered off, and so on while the power of the PC 1 remains ON.

When such a transition instruction is detected, the CPU 2 checks whether or not the SD™ card 8 has been attached into the SD™ card slot 7 in the first step S31.

In the next step S32, whether the SD™ card 8 has been attached or not is determined.

When it is determined that the SD™ card 8 has been attached as a result, the CPU 2 performs control processing for providing a message or alert on the display 17 to prompt removal of the SD™ card 8 from the SD™ card slot 7 in step S33, and returns to the processing of the step S31.

The user can recognize that it is better to remove the SD™ card 8 from the SD™ card slot 7 from such a display massage or the like, and thereby the user can perform the removal operation smoothly. Thus, user convenience can be enhanced.

On the other hand, when it is determined that the SD™ card 8 has not been attached in step S32, the CPU 2 performs an operation of transition to shutdown, standby, hibernation, or the like according to the transition instruction in step S34. After that, the process of FIG. 5 is completed. By the process of FIG. 5, the user can prevent or inhibit that the instruction to make a transition to shutdown or the like is executed when the SD™ card 8 remains attached into the SD™ card slot 7 of the PC 1.

As mentioned above, when a divided file B that is a counterpart of a divided file A stored in the HDD 6 has been stored in the SD™ card 8, and the SD™ card 8 remains attached to the PC 1, security function is reduced.

To allow the prevention of reduction in the security function, as shown in FIG. 5, if a user gives a transition instruction to make a transition of the PC 1 from a normal usage condition to a condition where the PC is not used, a massage display or the like to prompt removal of the SD™ card 8 is provided before the transition instruction is executed, and thereby a user is prompted to avoid a condition causing security reduction.

Some parts of the process of FIG. 5 may be modified as follows.

In step S32 of FIG. 5, when the CPU 2 determines that the SD™ card 8 has been attached, the CPU 2 may perform further processing for searching for a divided file (into which a confidential file is divided) stored in the SD™ card 8.

When the divided file is found by the search, the process may proceed to step S33 in which a massage display or the like to prompt removal of the SD™ card 8 is performed, and, when there is no divided file on the contrary, the process may proceed to step S34.

By the process as described above, a security function for a confidential file can be prevented from being reduced in such a case where the confidential file is divided, and the other divided file as a divided file other than one of the divided files is stored in the SD™ card 8.

On the other hand, when a divided file has not been stored in the SD™ card 8, shutdown or the like is accepted or allowed since information stored in the SD™ card 8 is assumed to be irrelevant to the security of the confidential file.

In the above described embodiment, as a storage means which is removable from the PC 1 (or the main body of the PC 1), the SD™ card 8 as a semiconductor memory, for example, which is nonvolatile and data-rewritable is used.

However, a flash memory device other than the SD™ card 8, for example, a USB memory may be employed. Further, a storage medium other than a semiconductor memory may be applied as well.

In addition, the present invention can allow an existing PC on which the above described program data 18 has not been installed to be provided with the above described functions by installing the program data 18 on the PC through a storage medium or a network on which the program data 18 is recorded.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An information processor, comprising:
a first storage device configured to be able to store information, the first storage device being mounted in a main body of the information processor;
a storage device attaching section to/from which a second storage device configured to be able to store information can be attached/detached, the storage device attaching section being provided in the main body of the information processor;
a network interface device configured to connect with a network, the network interface device being provided in the main body of the information processor;
an instruction device configured to give a store instruction to store information;
a division processing unit configured to divide predetermined information to which the store instruction is applied so as to generate first divided information and second divided information; and
a controller configured to perform control to store the first divided information and the second divided information in the first storage device and the second storage device respectively, and control to store the second divided information to be stored in the second storage device into a third storage device connected to the network through the network interface device.

2. The information processor according to claim 1, further comprising an encryption processing unit configured to encrypt the information to which the store instruction is applied.

3. The information processor according to claim 2, further comprising a decryption processing unit configured to decrypt the information encrypted by the encryption processing unit.

4. The information processor according to claim 1, further comprising a combining processing unit configured to combine the first divided information and the second divided information into the information prior to being divided.

5. The information processor according to claim 1, wherein the division processing unit divides the information to which the store instruction is applied on a per bit basis to generate the first divided information and the second divided information.

6. The information processor according to claim 1, wherein the division processing unit divides the predetermined information to which the store instruction is applied to generate the first divided information having a larger amount of information and the second divided information having a smaller amount of information.

7. The information processor according to claim 1, wherein the division processing unit generates encrypted information from the predetermined information to which the store instruction is applied and generates the first divided information and the second divided information from the encrypted information.

8. The information processor according to claim 1, wherein the controller determines whether or not the second divided information can be stored in the third storage device.

9. The information processor according to claim 8, wherein the controller performs control to store the second divided information only in the second storage device when the controller determines that the second divided information cannot be stored in the third storage device.

10. The information processor according to claim 1, wherein the controller performs control to automatically store divided information which has not been stored in the third storage device and has been stored in the second storage device into the third storage device when the main body of the information processor is connected to the network or when the second storage device is attached to the main body of the information processor.

11. The information processor according to claim 1, wherein, when an instruction to make a transition to a low power consumption mode including at least one of shutdown, standby, and pause processing is given in a condition where the second storage device has been attached to the main body of the information processor, the controller performs control to restrict the transition or provide an alert to a user.

12. The information processor according to claim 1, wherein the controller reads out the first divided information from the first storage device and reads out the second divided information corresponding to the first divided information from the second storage device or the third storage device with reference to additional information added to the first divided information when a reproduction instruction is given by the instruction device.

13. The information processor according to claim 12, wherein the first divided information and the second divided information which are read out by the controller are combined to generate information prior to being divided.

14. The information processor according to claim 13, wherein, if the information prior to being divided is encrypted information, the information prior to being divided is decrypted and turned into information prior to being encrypted.

15. The information processor according to claim 1, wherein the second storage device is composed of a nonvolatile semiconductor memory.

16. An information processor, comprising:
a first storage device in which a first divided information that is divided from predetermined information is stored, the first storage device being mounted in a main body of the information processor;
a storage device attaching section to/from which a removable second storage device can be attached/detached, the storage device attaching section being provided in the main body of the information processor, the removable second storage device storing second divided information which is other divided information than the first divided information divided from the predetermined information; and
a controller configured to, when an instruction to make a transition to a low power consumption mode including at least one of shutdown, standby, and pause processing is given in a condition where the second storage device has been attached to the storage device attaching section, perform control to inhibit the transition or provide an alert.

17. The information processor according to claim 16, wherein the controller determines whether or not the second storage device has been removed from the storage device attaching section after providing the alert, and allows a transition to the low power consumption mode when the controller determines that the device has been removed.

18. An information processing method, comprising:
dividing predetermined information into first divided information and second divided information in response to a store instruction with respect to the predetermined information; and
storing the first divided information in a first storage device mounted in a main body of an information processor configured to perform information processing, and storing the second divided information in a second storage device removably attached to the main body of the information processor as well as in a third storage device on a network through a network interface provided in the main body of the information processor.

19. The information processing method according to claim 18, further comprising encrypting the predetermined information before dividing the predetermined information into the first divided information and the second divided information in response to the store instruction with respect to the predetermined information.

20. The information processing method according to claim 18, further comprising combining the predetermined information prior to being divided, from the first divided information and the second divided information, in response to a reproduction instruction.
